(19) United States
(12) Patent Application Publication
(10) Pub. No.: US 2024/0271415 A1
(43) Pub. Date: Aug. 15, 2024

(54) A SELF-ADHERING BITUMINOUS SEALING ELEMENT WITH IMPROVED BONDING AT LOW TEMPERATURES

(71) Applicant: SIKA TECHNOLOGY AG, Baar (CH)

(72) Inventors: Johannes PECHER, Dossobuono (IT); Jan SPENGLER, Breuberg (DE); Simon SCHOENBRODT, Sarnen (CH); Gina FRUTIGER, Meiringen (CH)

(73) Assignee: SIKA TECHNOLOGY AG, Baar (CH)

(21) Appl. No.: 18/569,534

(22) PCT Filed: Jul. 5, 2022
(86) PCT No.: PCT/EP2022/068505

§ 371 Date: Dec. 12, 2023

(30) Foreign Application Priority Data
Jul. 7, 2021 (EP) 21184353.7

(51) Int. Cl. E04B 1/66; C09J 7/38; C09J 195/00

(52) U.S. Cl. CPC E04B 1/665; C09J 7/385; C09J 195/00; C09J 2203/346; C09J 2301/204; C09J 2301/208

(57) ABSTRACT

A sealing element includes: a waterproofing adhesive layer having first and second major surfaces, an adhesive layer covering at least a portion of the first major surface of the waterproofing adhesive layer, and a carrier layer on the side of the waterproofing adhesive layer opposite to the side of the adhesive layer, wherein the waterproofing adhesive layer is composed of a self-adhering bituminous composition and the adhesive layer is composed of a non-bituminous pressure sensitive adhesive. The sealing element is used as a waterproofing, roofing, vapor barrier, vapor retarder, or a façade membrane, or as a waterproofing, roofing tape, or façade tape.

### TECHNICAL FIELD

The invention relates to self-adhering sealing elements for use in the construction industry for sealing of below or above ground building constructions against penetration of water, moisture, harmful gases, or volatile organic compounds. In particular, the invention relates to self-adhering bituminous sealing elements, which are suitable for use as waterproofing, roofing, vapor barrier, vapor retarder, or façade membranes or tapes.

### BACKGROUND OF THE INVENTION

In the field of construction polymeric sheets, which are often referred to as membranes, panels, sheets, or liners, are used to protect underground and above ground constructions, such as base slabs, walls, floors, basements, tunnels, wet rooms, building facades, flat and low-sloped roofs, landfills, water-retaining structures, ponds, and dikes against penetration of water, moisture, harmful gases, and volatile organic compounds. Waterproofing membranes are applied, for example, to prevent ingress of water through cracks that develop in the concrete structure due to building settlement, load deflection or concrete shrinkage. Roofing membranes are used for sealing of flat and low-sloped roof structures to prevent leaks and to move take water off the roof. Vapor barrier and retarder membranes are used to control the movement of water through a building structure by vapor diffusion whereas façade tapes are used for sealing of construction gaps in building facades, for example to seal gaps between a building structure and window or curtain wall components.

The membranes used in the field of construction can be “post-applied” to an already existing concrete structure or “pre-applied” before the structure to be sealed has been formed. Pre-applied membranes are placed on the surface of the underlying concrete structure or formwork and fresh concrete is then cast against the outer surface of the membrane thereby fully and permanently bonding the membrane to the hardening concrete. The hardened concrete body can be part of a structure, in particular, an above-ground or underground structure, for example a building, garage, tunnel, landfill, water retention, pond, dike or an element for use in pre-fabricated constructions.

Post-applied membranes can be adhered to a surface of the substrate, for example, by using adhesives or mechanical fastening means, such as screws and/or barbed plates. The adhesive can be applied during installation or the membrane can comprise a factory applied pressure sensitive adhesive. Roofing membranes are typically adhered to roof substrates using contact bonding, where the membrane and the surface of the substrate are first coated with a solvent- or water-based contact adhesive to form wet adhesive layers. The volatile components of the adhesive are then allowed to evaporate to provide a partially dried adhesive films, which are then contact with each other. Self-adhering membranes and tapes typically contain a release liner to prevent premature unwanted adhesion and to protect the pressure sensitive adhesive layer from moisture, fouling, and other environmental factors. At the time of use the release liner is removed and the membrane is attached to the substrate without using additional adhesives. Self-adhering membranes are also known as “peel and stick” membranes.

Commonly used materials for membranes and tapes include thermoplastics, such as plasticized polyvinylchloride (p-PVC) and thermoplastic olefins (TPE-O, TPO), bitumen, and crosslinked elastomers, such as ethylene-propylene diene monomer (EPDM) rubber. Bitumen compositions are typically modified with synthetic polymers to improve flexibility at low temperatures, resistance to UV-radiation, and toughness. Bitumen membranes and tapes are widely used in roofing, terraces, tank lining, podiums, below-grade structures, and basements since they provide good resistance against environmental factors combined with relatively low costs compared to thermoplastic polymer materials and rubbers.

Bitumen-based membranes are provided as “torch-on” (torch-applied) and peel and stick versions. Torch-on bitumen membranes are rolled out onto the substrate, and a construction worker uses a hand-held propane torch to heat the material and adhere it to the surface of the substrate. Torch-on membranes typically comprise a reinforcing layer, such as layer of polyester fabric, to improve the mechanical stability of the membrane, and a surface finishing composed of particles of inorganic minerals, such as sand. The main disadvantage of torch-on membranes relates to the complicated and dangerous installation process, which requires the use of a gas torch with an open flame operating at extremely high temperatures.

Peel and stick bitumen membranes comprising a self-adhering bituminous layer are much easier to install than the torch-on membranes, but they also provide a very limited tack at low temperatures, especially at below 10° C. Therefore, installation of self-adhering bitumen membranes at low temperatures requires heating of the membrane as well as the substrate to be sealed, which complicates the installation process and increases the installation costs. Furthermore, self-adhering bitumen cannot be adhered to wet/humid substrates, which further limits their applicability at low temperatures.

There thus remains a need for a self-adhering bituminous sealing element, which provides high tack at low temperatures, particularly at below 10° C., and bonding to wet/humid substrates.

### SUMMARY OF THE INVENTION

The object of the present invention is to provide a self-adhering bitumen-based sealing element, which can be used for sealing underground and above ground constructions at low temperatures without additional heating of the sealing element or the substrate to be sealed.

The subject of the present invention is a sealing element as defined in claim 1.

It was surprisingly found out that a sealing element comprising a waterproofing adhesive layer composed of a self-adhering bituminous composition and the adhesive layer composed of a non-bituminous pressure sensitive adhesive provides good bonding to substrates even at temperatures of below 10° C.

One of the advantages of the sealing element of the present invention is that provides a low-cost version to the thermoplastic and rubber-based self-adhering membranes and tapes while still providing similar performance in terms of mechanical properties and long-term stability against environmental factors. Another advantage of the claimed the sealing element is that it can installed without using a gas torch with an open flame while still providing sufficient tack at low temperatures.

Other subjects of the present invention are presented in other independent claims. Preferred embodiments of the invention are presented in the dependent claims.

### BRIEF DESCRIPTION OF THE DRAWINGS

FIG. 1 shows a perspective view of a sealing element (1) having a width (w) defined between opposite longitudinally extending edges and comprising a waterproofing adhesive layer (2), an adhesive layer (3) covering a portion of the first major surface of the waterproofing adhesive layer (2), and a carrier layer (4) on the side of the waterproofing adhesive layer (2) that is opposite to the side of the adhesive layer (3).

FIG. 2 shows a perspective view of a sealing element (1), wherein the adhesive layer (3) has a pattern comprising a plurality of spaced-apart adhesive coated areas in form of adhesive stripes extending in the longitudinal direction (L) of the sealing element (1).

FIG. 3 shows a perspective view of a sealing element (1), wherein the adhesive layer (3) has a pattern comprising a plurality of spaced-apart adhesive coated areas in form of adhesive stripes extending in the transverse direction of the sealing element (1).

FIG. 4 shows a perspective view of a sealing element (1) wherein the adhesive layer (3) has a pattern comprising a plurality of spaced-apart adhesive coated areas that in form of circular dots.

FIG. 5 shows a perspective view of a sealing element (1) wherein the adhesive layer (3) has a pattern comprising a plurality of spaced-apart adhesive coated areas in form of rectangular dots.

FIG. 6 shows a perspective view of a sealing element (1) wherein the adhesive layer (3) has a pattern comprising an adhesive coated area and a plurality of spaced-apart adhesive free areas having a rectangular shape.

FIG. 7 shows a perspective view of a sealing element (1) wherein the adhesive layer (3) has a pattern comprising an adhesive coated area and a plurality of spaced-apart adhesive free areas having a circular shape.

FIG. 8 shows a cross-section of a sealing element (1) comprising a waterproofing adhesive layer (2), an adhesive layer (3) covering a portion of the first major surface of the waterproofing adhesive layer (2), and a carrier layer (4) on the side of the waterproofing adhesive layer (2) that is opposite to the side of the adhesive layer (3), wherein the adhesive layer (3) is partially embedded into the waterproofing adhesive layer (2). The sealing element (1) further comprises a release liner (5) covering the outer major surface of the adhesive layer (3) facing away from the waterproofing adhesive layer (2).

FIG. 9 shows a cross-section of a sealed substrate comprising a substrate (6) and a sealing element (1), wherein the outer major surface of the adhesive layer (3) and a portion of the first major surface of the waterproofing adhesive layer (2) are directly connected to the surface of the substrate (6).

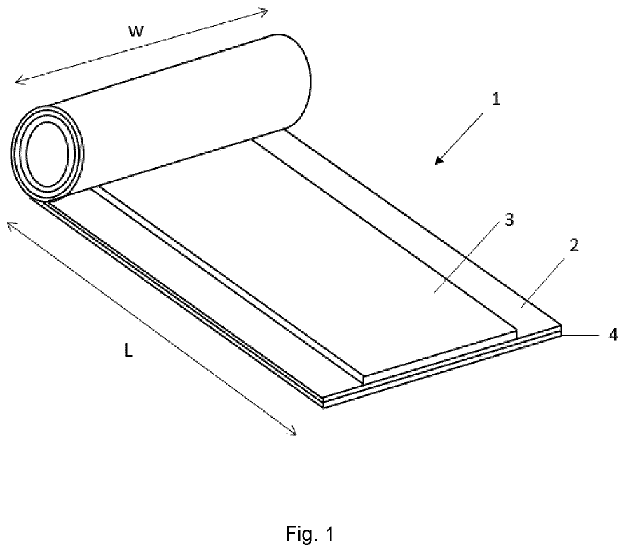

### DETAILED DESCRIPTION OF THE INVENTION

The subject of the present invention is sealing element (1) comprising:
i. A waterproofing adhesive layer (2) having first and second major surfaces,
ii. An adhesive layer (3) covering at least a portion of the first major surface of the waterproofing adhesive layer (2), and
iii. A carrier layer (4) on the side of the waterproofing adhesive layer (2) opposite to the side of the adhesive layer (3), wherein
the waterproofing adhesive layer (2) is composed of a self-adhering bituminous composition and the adhesive layer (3) is composed of a non-bituminous pressure sensitive adhesive.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” designates a collective of chemically uniform macromolecules produced by a polyreaction (polymerization, polyaddition, polycondensation) where the macromolecules differ with respect to their degree of polymerization, molecular weight, and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “elastomer” refers to any polymer or combination of polymers, which is capable of recovering from large deformations. Typical elastomers are capable of being elongated or deformed to at least 200% of their original dimension under an externally applied force, and will substantially resume the original dimensions, sustaining only small permanent set (typically no more than about 20%), after the external force is released. As used herein, the term “elastomer” may be used interchangeably with the term “rubber.” In particular, the term “elastomer” refers to elastomers that are not chemically crosslinked. The term “chemically crosslinked” is understood to mean that the polymer chains forming the elastomer are inter-connected by a plurality of covalent bonds, which are stable mechanically and thermally.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “melting temperature” refers to a temperature at which a material undergoes transition from the solid to the liquid state. The melting temperature (Tₘ) is preferably determined by differential scanning calorimetry (DSC) according to ISO 11357-3 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one acrylic polymer AP” refers to the sum of the individual amounts of all acrylic polymers AP contained in the composition. Furthermore, in case the composition comprises 20 wt.-% of at least one acrylic polymer AP, the sum of the amounts of all acrylic polymers AP contained in the composition equals 20 wt.-%.

The term “room temperature” designates a temperature of 23° C.

The sealing element comprises as a first compulsory component a waterproofing adhesive layer (2) composed of a self-adhering bituminous composition. The term “layer” refers in the present disclosure to a sheet-like element having first and second major surfaces, i.e. top and bottom surfaces, defining a thickness of the layer therebetween. Preferably, the term “layer” refers to a sheet-like element having a length and width of at least 15 times, more preferably at least 25 times, even more preferably at least 50 times, greater than the thickness of the sheet-like element.

The composition of the self-adhering bituminous composition is not particularly restricted as long as it provides the waterproofing adhesive layer with sufficient waterproofing and adhesive properties. According to one or more embodiments, the self-adhering bituminous composition comprises:
a) 15-95 wt.-%, preferably 25-85 wt.-%, more preferably 35-75 wt.-%, even more preferably 40-70 wt.-%, of bitumen B and
b) 5-35 wt.-%, preferably 10-30 wt.-%, more preferably 15-30 wt.-%, even more preferably 20-30 wt.-%, of at least one modifying polymer MP, all proportions being based on the total weight of the self-adhering bituminous composition.

The term “bitumen” designates in the present disclosure blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically have low penetration values and high softening-points.

According to one or more embodiments, the bitumen B comprises at least 75 wt.-%, preferably at least 85 wt.-%, more preferably at least 90 wt.-% of at least one penetration grade bitumen, preferably having a penetration value in the range of 30-300 dmm, more preferably 70-220 dmm, even more preferably 100-160 and/or a softening point determined by Ring and Ball measurement conducted according to DIN EN 1238 standard in the range of 30-100° C., more preferably 30-70° C., even more preferably 30-50° C.

Suitable compounds for use as the modifying polymer MP include, for example, polyolefins, such as atactic polypropylene (APP), amorphous polyolefins (APO), styrene block copolymers, and rubbers.

The term “amorphous polyolefin (APO)” refers in the present disclosure to polyolefins to having a low crystallinity degree determined by a differential scanning calorimetry (DSC) measurements, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. In particular, the term “amorphous polyolefin” designates poly-α-olefins lacking a crystalline melting point (Tₘ) as determined by differential scanning calorimetric (DSC) or equivalent technique.

Suitable amorphous polyolefins for use as the modifying polymer MP include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Suitable styrene block copolymers for use as the modifying polymer MP include, particularly styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks. Preferred styrene block copolymers for use as the modifying polymer MP include at least styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

Suitable rubbers for use as the modifying polymer MP include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

According to one or more embodiments, the self-adhering bituminous composition further comprises:
c) 2.5-30 wt.-%, preferably 5-25 wt.-%, of at least one tackifying resin TR and/or
d) 0.5-15 wt.-%, preferably 2.5-10 wt.-%, of at least one plasticizer PL and/or
e) 2.5-30 wt.-%, preferably 5-25 wt.-%, of at least one inorganic filler F, all proportions being based on the total weight of the self-adhering bituminous composition.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C. Examples of suitable tackifying resins include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins. Monomers that may be polymerized to synthesize the synthetic resins may include aliphatic monomer, cycloaliphatic monomer, aromatic monomer, or mixtures thereof. Aliphatic monomers can include C4, C5, and C6 paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C8, C9, and C10 aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH); and under the trade name of Kristalex®, Plastolyn®, Piccotex®, Piccolastic® and Endex® (all from Eastman Chemicals).

According to one or more embodiments, the at least one tackifying resin TR
a softening point measured by a Ring and Ball method according to DIN EN 1238 standard in the range of 65-185° C., preferably 75-175° C., more preferably 80-170° C. and/or
a number average molecular weight (Mₙ) in the range of 150-5000 g/mol, preferably 250-3500 g/mol, more preferably 250-2500 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° ° C., more preferably at or above 25° C., even more preferably at or above 30° C., still more preferably at or above 35° C.

Suitable compounds to be used as plasticizers PL are liquid plasticizers, wherein the term “liquid” is defined as a material that flows at normal room temperature, has a pour point of less than 20° C. and/or a kinematic viscosity at 25° C. of 50000 cSt or less.

According to one or more embodiments, the at least one plasticizer PL is selected from the group consisting of mineral oils, synthetic oils, vegetable oils, and at 25° C. liquid hydrocarbon resins.

The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In other words, the term “mineral” refers in the present disclosure to refined mineral oils, which can be also characterized as Group I-III base oils according the classification of the American Petroleum Institute (API).

Suitable mineral oils to be used as the plasticizer PL include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

Suitable at 25° C. liquid hydrocarbon resins for use as the plasticizer PL include at 25° C. liquid polybutenes and at 25° C. liquid polyisobutylenes (PIB). The term “at 25° C. liquid polybutene” designates in the present disclosure low molecular weight olefin oligomers comprising isobutylene and/or 1-butene and/or 2-butene. The ratio of the C4-olefin isomers can vary by manufacturer and by grade. When the C4-olefin is exclusively 1-butene, the material is referred to as “poly-n-butene” or “PNB”. The term “at 25° C. liquid polyisobutylene” designates in the present disclosure low molecular weight polyolefins and olefin oligomers of isobutylene, preferably containing at least 75%, more preferably at least 85% of repeat units derived from isobutylene. Particularly suitable at 25° C. liquid polybutenes and polyisobutylenes have a molecular weight (Mₙ) of not more than 10000 g/mol, preferably not more than 5000 g/mol, more preferably not more than 3500 g/mol, even more preferably not more than 3000 g/mol, still more preferably not more than 2500 g/mol.

Liquid polybutenes are commercially available, for example, under the trade name of Indopol® H- and L-series (from Ineos Oligomers), under the trade name of Infineum® C-series and Parapol® series (from Infineum), and under the trade name of PB-series (Daelim). Liquid polyisobutylenes (PIBs) are commercially available, for example, under the trade name of Glissopal® V-series (from BASF) and under the trade name of Dynapak®-series (from Univar GmbH, Germany).

The term “inert mineral filler” designates in the present document mineral fillers, which, unlike mineral binders, do not undergo a hydration reaction in the presence of water.

Suitable compounds to be used as the inorganic filler F include, for example, sand, granite, calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

The term “sand” refers in the present disclosure to mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” as inert mineral filler refers in the present document to calcitic fillers produced from chalk, limestone, or marble by grinding and/or precipitation.

According to one or more embodiments, the at least one inorganic filler F is selected from the group consisting of calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, and fused silica.

Preferably, the at least one inorganic filler F has a median particle size d₅₀ of not more than 150 μm, more preferably not more than 100 μm. According to one or more embodiments, the at least one solid filler F has a median particle size d₅₀ of 0.1-100 μm, preferably 0.15-50 μm, more preferably 0.15-25 μm, even more preferably 0.25-15 μm.

The term “particle size” refers in the present disclosure to the area-equivalent spherical diameter of a particle (Xₐᵣₑₐ). The term “median particle size d₅₀” refers to a particle size below which 50% of all particles by volume are smaller than the d₅₀ value. In analogy, the term doo particle size refers in the present disclosure to a particle size below which 90% of all particles by volume are smaller than the d₉₀ value and term “d₁₀ particle size” refers to a particle size below which 10% of all particles by volume are smaller than the d₁₀ value. A particle size distribution can be measured by laser diffraction according to the method as described in standard ISO 13320:2009 using a wet or dry dispersion method and for example, a Mastersizer 2000 device (trademark of Malvern Instruments Ltd, GB).

The thickness of the waterproofing adhesive layer is not particularly restricted, and it depends mainly on the intended application of the sealing element. Preferably, the waterproofing adhesive layer has a thickness of not more than 10 mm, more preferably not more than 7.5 mm, even more preferably not more than 5 mm. According to one or more embodiments, the waterproofing adhesive layer has a thickness of 0.1-5 mm, preferably 0.15-3 mm, more preferably 0.2-2.5 mm. even more preferably 0.2-1.5 mm, still more preferably 0.2-1, most preferably 0.2-0.8 mm.

The sealing element comprises as the second compulsory component an adhesive layer (3) composed of a non-bituminous pressure sensitive adhesive.

The term “pressure sensitive adhesive” refers in the present disclosure to viscoelastic materials, which adhere immediately to almost any kind of substrates by application of light pressure and which are permanently tacky. The term “non-bituminous” is understood to mean that the pressure sensitive adhesive is essentially free of bitumen, i.e. the amount of bitumen in the pressure sensitive adhesive is less than 1 wt.-%, preferably less than 0.5 wt.-%, more preferably less than 0.1 wt.-%, based on the total weight of the pressure sensitive adhesive.

Preferably, the adhesive layer has a loop tack adhesion to a glass plate measured at a temperature of 23° C. of at least 2.5 N/25 mm, preferably at least 5 N/25 mm, more preferably at least 10 N/25 mm, wherein the loop tack adhesion is measured using a ″FINAT test method no. 9 (FTM 9) as defined in FINAT Technical Handbook, 9th edition, published in 2014.

Suitable non-bituminous pressure sensitive adhesives include adhesives based on acrylic polymers, styrene block copolymers, amorphous polyolefins (APO), amorphous poly-alpha-olefins (APAO), vinyl ether polymers, and elastomers such as, for example, styrene-butadiene rubber (SBR), ethylene propylene diene monomer (EPDM) rubber, butyl rubber, polyisoprene, polybutadiene, natural rubber, polychloroprene rubber, ethylene-propylene rubber (EPR), nitrile rubber, acrylic rubber, ethylene vinyl acetate (EVA) rubber, and silicone rubber. In addition to the above-mentioned polymers, suitable pressure sensitive adhesives typically comprise one or more additional components including, for example, tackifying resins, waxes, and additives, for example, UV-light absorption agents, UV- and heat stabilizers, optical brighteners, pigments, dyes, and desiccants.

According to one or more embodiments, the non-bituminous pressure sensitive adhesive is selected from the group consisting of styrene block copolymer pressure sensitive adhesives, rubber pressure sensitive adhesives, and acrylic pressure sensitive adhesives.

According to one or more embodiments, the non-bituminous pressure sensitive adhesive is a styrene copolymer-based adhesive comprising:
A) 15-75 wt.-%, preferably 25-65 wt.-%, more preferably 35-60 wt.-%, of at least one styrene block copolymer SC,
B) 2.5-85 wt.-%, preferably 5-75 wt.-%, more preferably 10-65 wt.-%, of at least one tackifying resin,
C) 0-35 wt.-%, preferably 2.5-25 wt.-%, more preferably 5-15 wt.-%, of at least one inert mineral filler,
D) 0-30 wt.-%, preferably 2.5-25 wt.-%, more preferably 5-15 wt.-%, of at least one plasticizer, all proportions being based on the total weight of the non-bituminous pressure sensitive adhesive.

According to one or more embodiments, the at least one styrene block copolymer SC is selected from the group consisting of styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers.

According to one or more further embodiments, the non-bituminous pressure sensitive adhesive is a rubber-based adhesive comprising:
A) 15-75 wt.-%, preferably 25-65 wt.-%, more preferably 35-60 wt.-%, of at least one elastomer E,
B) 2.5-85 wt.-%, preferably 5-75 wt.-%, more preferably 10-65 wt.-%, of at least one tackifying resin,
C) 0-35 wt.-%, preferably 2.5-25 wt.-%, more preferably 5-15 wt.-%, of at least one inert mineral filler,

According to one or more embodiments, the at least one elastomer E is selected from the group consisting of styrene-butadiene rubber (SBR), ethylene propylene diene monomer (EPDM) rubber, butyl rubber, polyisoprene, polybutadiene, natural rubber, polychloroprene rubber, ethylene-propylene rubber (EPR), nitrile rubber, acrylic rubber, ethylene vinyl acetate (EVA) rubber, and silicone rubber.

The preferences given above for the types of the at least one tackifying resin TR and the at least one plasticizer PL apply equally to the at least one tackifying resin and the at least one plasticizer of the non-bituminous pressure sensitive adhesive.

According to one or more preferred embodiments, the non-bituminous pressure sensitive adhesive is an acrylic pressure sensitive adhesive. The term “acrylic pressure sensitive adhesive” designates in the present disclosure pressure sensitive adhesives containing one or more acrylic polymers as the main polymer component.

The term “acrylic polymer” designates in the present disclosure homopolymers, copolymers and higher inter-polymers of an acrylic monomer with one or more further acrylic monomers and/or with one or more other ethylenically unsaturated monomers and the term “acrylic monomer” refers to monomers having at least one (meth)acryloyl group in the molecule. The term “(meth)acryloyl” designates methacryloyl or acryloyl. Accordingly, the term “(meth)acrylic” designates methacrylic or acrylic. A (meth)acryloyl group is also known as (meth)acryl group.

According to one or more embodiments, the acrylic pressure sensitive adhesive comprises at least 50 wt.-%, preferably at least 65 wt.-%, more preferably at least 75 wt.-%, of at least one acrylic polymer AP, based on the total weight of the acrylic pressure sensitive adhesive.

Examples of suitable acrylic monomers for use in the at least one acrylic polymer AP include, for example, (meth)acrylates, (meth)acrylic acid or derivatives thereof, for example, amides of (meth)acrylic acid or nitriles of (meth)acrylic acid, and (meth)acrylates with functional groups such as hydroxyl group-containing (meth)acrylates and alkyl (meth)acrylates.

According to one or more embodiments, the at least one acrylic polymer AP
a glass transition temperature (T_{g}) determined by dynamical mechanical analysis (DMA) as the peak of the measured loss modulus (G″) curve using an applied frequency of 1 Hz and a strain level of 0.1% of below 5° C., preferably of below 0° C., more preferably below −10° C., even more preferably below −20° C. and/or
a number average molecular weight (Mₙ) of 50000-1000000 g/mol, preferably 100000-750000 g/mol, more preferably 150000-500000 g/mol.

According to one or more embodiments, the acrylic polymer AP has been obtained from a monomer mixture comprising at least 45 wt.-%, preferably at least 55 wt.-%, more preferably at least 65 wt.-%, even more preferably at least 75 wt.-%, still more preferably at least 85 wt.-%, based on the total weight of the monomer mixture, of acrylic monomers of formula (I):

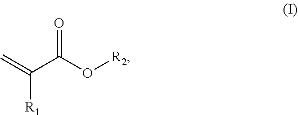

where
R₁ represents a hydrogen or a methyl group; and
R₂ represents a branched, unbranched, cyclic, acyclic, or saturated alkyl group having from 2 to 30 carbon atoms.

Examples of preferred acrylic monomers of formula (I) include methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable comonomers to be used with the acrylic monomers of formula (I) include, for example, hydroxyl group containing acrylic monomers, such as 2-hydroxyethyl(meth)acrylate, 2-hydroxypropyl(meth)acrylate, 3-hydroxypropyl (meth)acrylate, 2-hydroxybutyl(meth)acrylate, 4-hydroxybutyl butyl(meth)acrylate, 2-hydroxy-hexyl(meth)acrylate, 6-hydroxy hexyl(meth) acrylate, 8-hydroxyoctyl(meth)acrylate, 10-hydroxydecyl (meth)acrylate, 12-hydroxylauryl(meth)acrylate. Further suitable hydroxyl group containing acrylic monomers include (4-hydroxymethyl cyclohexyl)methyl acrylate, polypropylene glycol mono (meth)acrylate, N-hydroxyethyl (meth)acrylamide, and N-hydroxypropyl (meth)acrylamide.

According to one or more embodiments, the monomer mixture used for obtaining the at least one acrylic polymer AP comprises not more than 25 wt.-%, preferably not more than 20 wt.-%, such as 0.01-15 wt.-%, preferably 0.1-10 wt.-%, based on the total weight of the monomer mixture, of at least one hydroxyl group containing acrylic monomer.

Further suitable comonomers for the synthesis of at least one acrylic polymer AP include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of suitable vinyl compounds include, for example, maleic anhydride, styrene, styrenic compounds, acrylic acid, beta-acryloyloxypropionic acid, vinylacetic acid, fumaric acid, crotonic acid, aconitic acid, trichloroacrylic acid, itaconic acid, and vinyl acetate.

According to one or more embodiments, the monomer mixture used for obtaining the at least one acrylic polymer AP comprises at least 0.1 wt.-%, preferably at least 0.5 wt.-%, such as 0.1-20 wt.-%, preferably 0.5-15 wt. %, based on the total weight of the monomer mixture, of at least one vinyl compound, preferably selected from the group consisting of maleic anhydride, styrene, styrenic compounds, (meth)acrylamides, N-substituted (meth)acrylamides, acrylic acid, beta-acryloyloxypropionic acid, vinylacetic acid, fumaric acid, crotonic acid, aconitic acid, dimethylacrylic acid, trichloroacrylic acid, itaconic acid, vinyl acetate, and amino group-containing (meth)acrylates.

According to one or more embodiments, the adhesive layer is a dried layer of a water- or solvent-based acrylic pressure sensitive adhesive composition, a layer of a hot-melt acrylic pressure sensitive adhesive composition, or a at least partially cured layer of a UV- or electron beam-curable acrylic pressure sensitive adhesive composition, preferably a dried layer of a water- or solvent-based acrylic pressure sensitive adhesive composition or a at least partially cured layer of a UV- or electron beam-curable acrylic pressure sensitive adhesive composition, wherein the adhesive layer preferably comprises at least 50 wt.-%, preferably at least 65 wt.-%, more preferably at least 75 wt.-%, of the at least one acrylic polymer AP, based on the total weight of the adhesive layer.

The term “water-based acrylic pressure sensitive adhesive composition” designates in the present disclosure acrylic pressure sensitive adhesives, which have been formulated as an aqueous dispersion, an aqueous emulsion, or as an aqueous colloidal suspension. The term “aqueous dispersion” or “aqueous emulsion” refers to dispersions or emulsions containing water as the main continuous (carrier) phase. Typically, a water-based acrylic pressure sensitive adhesive compositions comprise surfactants to stabilize the hydrophobic polymer particles and to prevent these from coagulating with each other.

The term “solvent-based acrylic pressure sensitive adhesive composition” designates in the present disclosure acrylic pressure sensitive adhesives comprising acrylic polymers, which are substantially completely dissolved in the organic solvent(s). Typically, the organic solvent(s) comprise at least 20 wt.-%, preferably at least 30 wt.-%, more preferably at least 40 wt.-%, of the total weight of the acrylic pressure sensitive adhesive composition. The term “organic solvent” refers in the present document to organic substances that are liquid at a temperature of 25° C., are able to dissolve another substance at least partially, and have a standard boiling point of not more than 225° C., preferably not more than 200° C. The term “standard boiling point” refers in the present disclosure to boiling point measured at a pressure of 1 bar. The standard boiling point of a substance or composition can be determined, for example, by using an ebulliometer.

Suitable organic solvents for the solvent-based acrylic pressure sensitive adhesive compositions include, for example, alcohols, aliphatic and aromatic hydrocarbons, ketones, esters, and mixtures thereof. It is possible to use only a single organic solvent or a mixture of two or more organic solvents. Suitable solvent-based acrylic pressure sensitive adhesive compositions are substantially water-free, for example, containing less than 10 wt.-%, preferably less than 5 wt.-%, more preferably less than 1 wt.-% of water, based on the total weight of the adhesive composition.

The term “acrylic hot-melt pressure sensitive adhesive composition” refers in the present disclosure to solvent-free acrylic pressure sensitive adhesives, which are applied as a melt.

The term “UV-curable acrylic pressure sensitive adhesive composition” refers in the present disclosure to acrylic pressure sensitive adhesives, which can be cured by initiation of photochemical curing reactions by UV-irradiation. The term “curing” refers here to chemical reactions comprising forming of bonds resulting, for example, in chain extension and/or crosslinking of polymer chains. The term “electron beam-curable acrylic pressure sensitive adhesive composition” refers in the present disclosure to acrylic pressure sensitive adhesives, which can be cured by initiation of curing reactions by electron beam irradiation.

According to one or more embodiments, the adhesive layer is a dried layer of a water- or solvent-based acrylic pressure sensitive adhesive composition, wherein the dried layer preferably comprises not more than 10 wt.-%, preferably not more than 7.5 wt.-%, more preferably not more than 5 wt.-%, even more preferably not more than 2.5 wt.-%, based on the total weight of the dried layer, of residual water and/or organic solvents.

According to one or more embodiments, the water- or solvent-based acrylic pressure sensitive adhesive composition comprises:
A) 25-85 wt.-%, preferably 35-75 wt.-%, of the at least one acrylic polymer AP and
B) 5-85 wt.-%, preferably 10-75 wt.-%, of water or at least one organic solvent, all proportions being based on the total weight of the acrylic pressure sensitive adhesive composition.

In addition to the at least one acrylic polymer AP, the water- or solvent-based acrylic pressure sensitive adhesive composition may further comprise one or more additional constituents including, for example, tackifying resins, waxes, and plasticizers as wells as one or more additives, such as UV-light absorption agents, UV- and heat stabilizers, optical brighteners, pigments, dyes, and desiccants. Preferably, the total amount of such additional constituents and additives is not more than 35 wt.-%, more preferably not more than 25 wt.-%, most preferably not more than 15 wt.-%, based on the total weight of the water—or solvent-based acrylic pressure sensitive adhesive composition.

According to one or more embodiments, the adhesive layer is a at least partially cured layer of a UV- or electron beam-curable acrylic pressure sensitive adhesive composition, preferably a at least partially cured layer of a UV-curable acrylic pressure sensitive adhesive composition.

According to one or more embodiments, the UV-curable acrylic pressure sensitive adhesive composition comprises:
A) at least 65 wt.-%, preferably at least 75 wt.-%, of the at least acrylic polymer AP,
B) 0-30 wt.-%, preferably 5-20 wt.-%, of at least one tackifying resin,
C) 0.01-5 wt.-%, preferably 0.1-1 wt.-%, of at least one cross-linking agent,
D) 0.1-5 wt.-%, preferably 0.25-2.5 wt.-%, of at least one photo initiator, all proportions being based on the total weight of the UV-curable acrylic pressure sensitive adhesive composition.

The at least one cross-linking agent is preferably a multifunctional acrylate selected from the group consisting of butanediol dimethacrylate, ethyleneglycol dimethacrylate, diethyleneglycol dimethacrylate, triethyleneglycol dimethacrylate, trimethylolpropane trimethacrylate, butanediol diacrylate, hexanediol diacrylate, trimethylolpropane triacrylate, and tripropyleneglycol diacrylate, trimethylolpropane ethoxy triacrylate, trimethylolpropane triacrylate, tripropylene glycol diacrylate, propylene glycol dimethacrylate, dipropylene glycol diacrylate, dipentaerythritol hydroxy pentaacrylate, neopentyl glycol propoxylate diacrylate, bisphenol A ethoxylate dimethacrylate, alkoxylated hexanediol diacrylate, ethoxylated bisphenol A diacrylate, ethoxylated bisphenol A dimethacrylate, ethoxylated trimethylolpropane triacrylate, propoxylated neopentyl glycol diacrylate, propoxylated glyceryl triacrylate, polybutadiene diacrylate, and polybutadiene dimethacrylate.

Suitable compounds to be used as the at least one photo initiator include, for example, benzoic ethers, dialkoxyacetophenones, alpha-hydroxycyclohexyl aryl ketones, alpha-ketophenylacetate esters, benzyldialkylketals, chloro- and alkylthioxanthones and alpha-amino- and alpha-hydroxyalkyl aryl ketones.

The thickness of the adhesive layer (3) is not particularly restricted, and it depends mainly on the intended application of the sealing element and on the type of non-bituminous pressure sensitive adhesive. Preferably, the adhesive layer (3) has a thickness of not more than 1000 μm, more preferably not more than 750 μm, even more preferably not more than 500 μm. According to one or more embodiments, the adhesive layer (3) has a thickness of 25-750 μm, preferably 50-500 μm, more preferably 75-350 μm, even more preferably 100-350 μm.

Preferably, the adhesive layer (3) covers at least 5%, more preferably at least 10%, even more preferably at least 15%, still more preferably at least 25%, of the area of the first major surface of the waterproofing adhesive layer (2) and/or not more than 95%, more preferably not more than 90%, even more preferably not more than 85%, still more preferably not more than 80%, of the area of the first major surface of the waterproofing adhesive layer (2). According to one or more embodiments, the adhesive layer (3) covers 25-85%, preferably 35-75%, even more preferably 35-65%, still more preferably 40-60%, of the area of the first major surface of the waterproofing adhesive layer (2).

The adhesive layer (3) can be a in form of a continuous or discontinuous adhesive layer. The term “continuous adhesive layer” is understood to mean that the adhesive layer is composed of one single area coated with the non-bituminous pressure sensitive adhesive. In contrast, the term “discontinuous adhesive layer” is understood to mean that the that the non-bituminous pressure sensitive adhesive has been applied to the waterproofing adhesive layer (3) in a pattern composed of adhesive coated areas and adhesive free areas (voids). In case of a discontinuous adhesive layer, the term “thickness of the adhesive layer” is understood to mean the arithmetic average of the thicknesses of the adhesive coated areas.

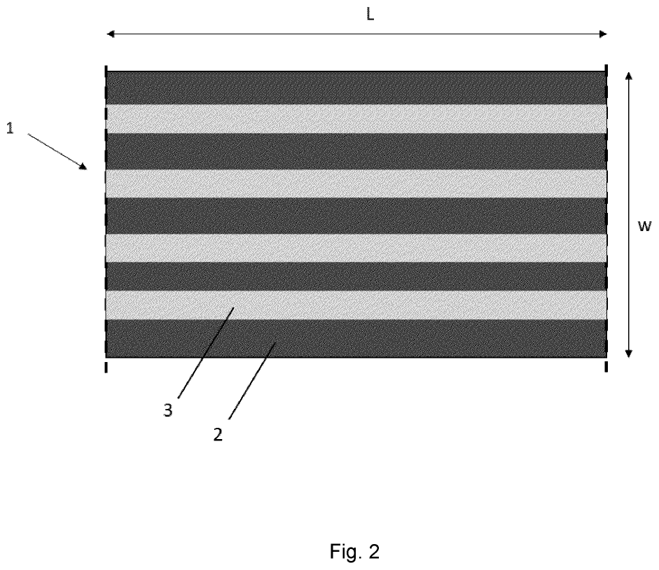

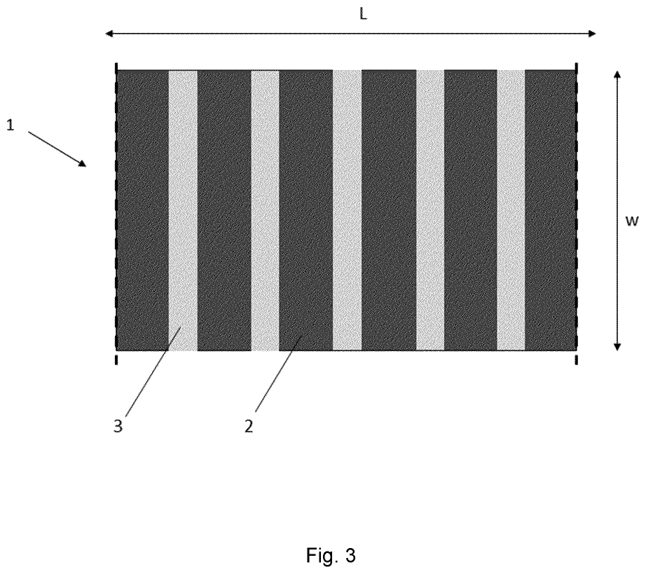

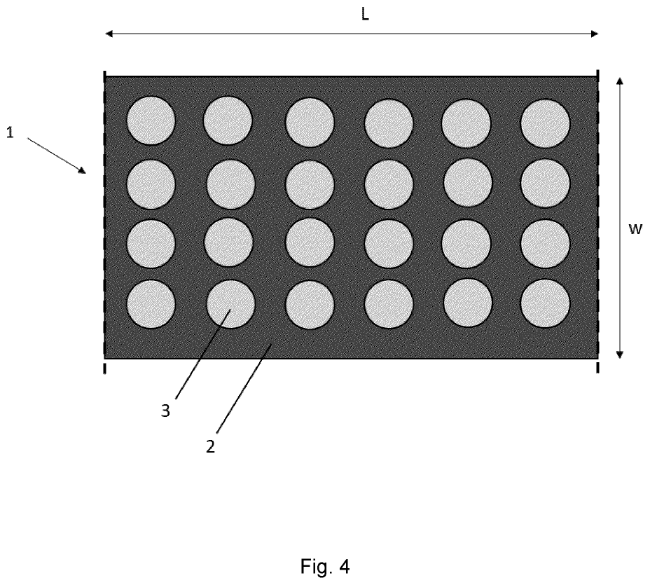

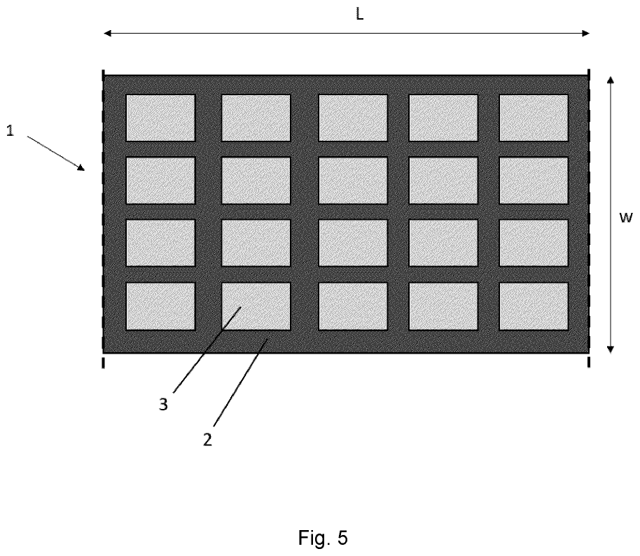

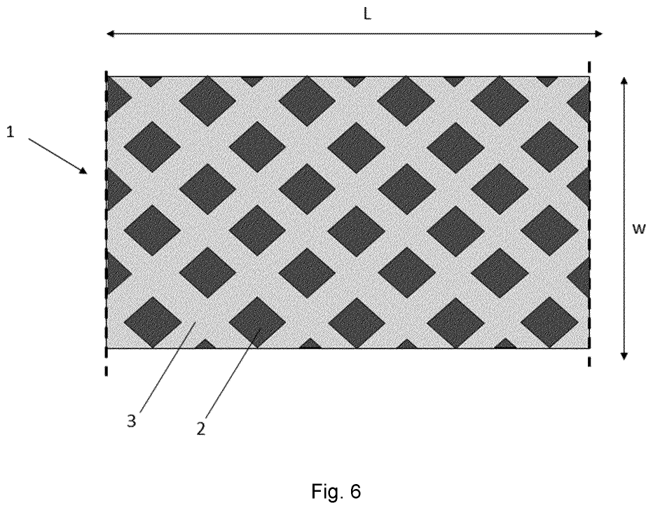

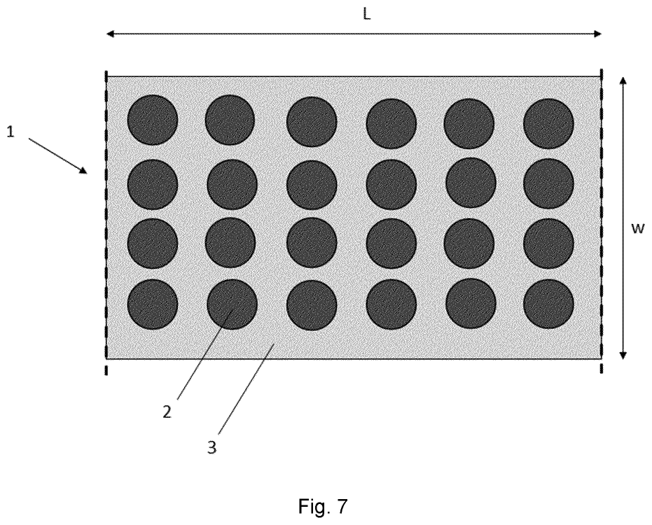

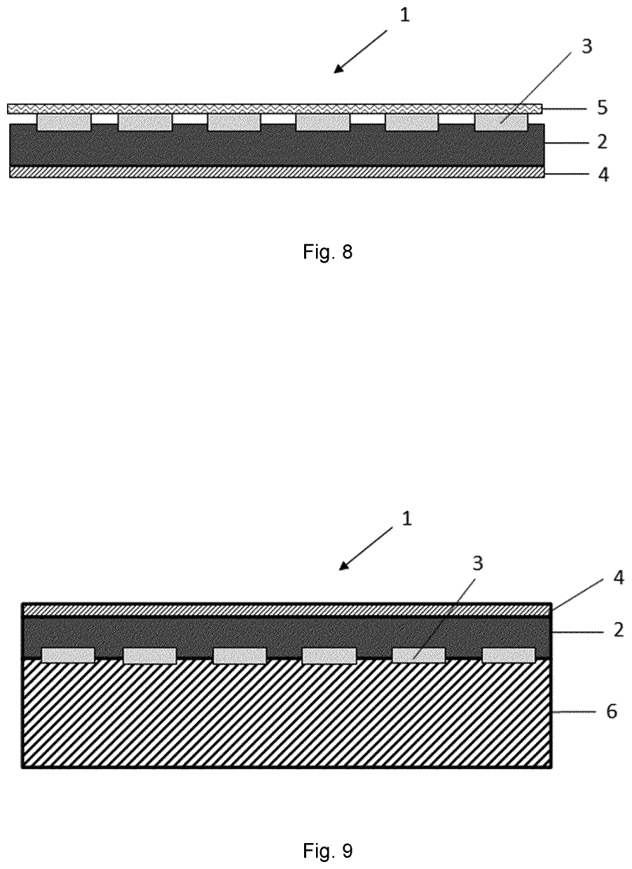

The adhesive pattern can be composed of a discontinuous network of adhesive coated areas and discontinuous network of adhesive free areas as shown in FIGS. 2 and 3, or of a discontinuous network of adhesive coated areas and a continuous network of adhesive free areas, as shown in FIGS. 4 and 5, or of a continuous network of adhesive coated areas and a discontinuous network of adhesive free areas, as shown in FIGS. 6 and 7.

According to or more preferred embodiments, the adhesive layer (3) has a pattern comprising a plurality of spaced-apart adhesive coated areas. The expression “spaced-apart” is understood to mean that adjacent adhesive coated areas are isolated from each other by an adhesive free area.

The spaced-apart adhesive coated areas can have any conventional shape, for example, circular, square, hexagonal, rectangular, polygonal, parallelogram, rhomboidal, or oval shape. Preferably, the minimum distance between two adjacent spaced-apart adhesive coated areas, before the adhesive layer (3) has been contacted with a surface of a substrate, is not less than 0.5 mm, more preferably not less than 1.5 mm, even more preferably not less than 2.5 mm.

According to one or more embodiments, the spaced-apart adhesive coated areas are in form of continuous stripes extending in the longitudinal (L), transverse, or diagonal direction of the sealing element. The term “in diagonal direction” is understood to mean a direction having an angle between the longitudinal (L) and transverse directions of the sealing element. The expression “continuous adhesive stripe” is understood to mean that each adhesive stripe extends uninterrupted from one peripheral edge to the other opposite peripheral edge of the waterproofing adhesive layer (2). Examples of sealing elements according to one of these embodiments are presented in FIGS. 2 and 3. The continuous adhesive stripes are preferably separated from each other by a distance of at least 5%, preferably at least 15%, more preferably at least 25%, of the width of each adhesive stripe.

The width of the continuous adhesive stripes is not particularly restricted, and the width may also vary along the length of the stripes. It is also possible that some adhesive stripes have a smaller or greater width than the other adhesive stripes. For example, it may be advantageous that in case of continuous longitudinally extending adhesive stripes, the adhesive stripes that are closer to the longitudinal edges of the adhesive waterproofing layer (2) have a smaller width than the adhesive stripes near the center of the waterproofing adhesive layer (2), or vice versa. In case of continuous adhesive stripes extending in a transverse direction, the adhesive stripes preferably have the same width.

According to one or more embodiments, each continuous adhesive stripe has a width corresponding to 2.5-25%, preferably 5-15% of the width of the waterproofing adhesive layer (2).

According to one or more further embodiments, the spaced-apart adhesive coated areas are in form of dots, preferably having a circular, square, hexagonal, rectangular, polygonal, parallelogram, rhomboidal, or oval shape, more preferably a circular, square, or rectangular shape. Examples of sealing elements according to these embodiments are presented in FIGS. 4 and 5.

The dots can be uniformly distributed, or their density can become reduced or increased in the longitudinal and/or transverse direction of the sealing element. Preferably, the dots are uniformly distributed. Furthermore, the dots can be configured such that they line up in rows or such that they are offset between rows.

The dots can have substantially same size, or their size can become reduced or increased in the longitudinal or transverse direction of the sealing element. By “substantially same size” is meant here that the percentage difference between sizes of any dots is not more than 35%, preferably, more preferably not more than 25%, even more preferably not more than 15%, most preferably not more than 5%.

Preferably, the dots have a size of at least 25 mm², more preferably at least 50 mm², even more preferably at least 100 mm². According to one or more further embodiments, the spaced-apart adhesive segments in form of dots have a size of 50-10000 mm², more preferably 100-5000 mm², even more preferably 150-3500 mm², still more preferably 250-2500 mm². The term “size a dot” refers here to the size of the area on the first major surface of the waterproofing adhesive layer (2) covered by an individual dot. According to one or more embodiments, the average size of the dots is in the range of 100-7500 mm², more preferably 150-5000 mm², even more preferably 250-2500 mm², still more preferably 350-1500 mm². The term “average size” designates the arithmetic average of the sizes.

According to one or more further embodiments, the adhesive layer (3) has a pattern comprising an adhesive coated area and a plurality of spaced-apart adhesive free areas. Examples of a sealing elements according to these embodiments are presented in FIGS. 6 and 7.

The spaced-apart adhesive free areas can have any conventional shape, for example, circular, square, hexagonal, rectangular, polygonal, parallelogram, rhomboidal, or oval shape. Preferably, the minimum distance between two adjacent spaced-apart adhesive free areas, before the adhesive layer (3) has been contacted with a surface of a substrate, is not less than 0.5 mm, more preferably not less than 1.5 mm, even more preferably not less than 2.5 mm.

The spaced-apart adhesive free areas can be uniformly distributed, or their density can become reduced or increased in the longitudinal and/or transverse direction of the sealing element. Preferably, the spaced-apart adhesive free areas are uniformly distributed. Furthermore, the spaced-apart adhesive free areas can be configured such that they line up in rows or such that they are offset between rows.

The spaced-apart adhesive free areas can have substantially same size, or their size can become reduced or increased in the longitudinal or transverse direction of the sealing element. By “substantially same size” is meant here that the percentage difference between sizes of any spaced-apart adhesive free areas is not more than 35%, preferably, more preferably not more than 25%, even more preferably not more than 15%, most preferably not more than 5%.

Preferably, the spaced-apart adhesive free areas have a size of at least 25 mm², more preferably at least 50 mm², even more preferably at least 100 mm². According to one or more further embodiments, the spaced-apart adhesive free areas have a size of 50-10000 mm², more preferably 100-5000 mm², even more preferably 150-3500 mm², still more preferably 250-2500 mm².

According to one or more embodiments, the average size of the spaced-apart adhesive free areas is in the range of 100-7500 mm², more preferably 150-5000 mm², even more preferably 250-2500 mm², still more preferably 350-1500 mm². The term “average size” designates the arithmetic average of the sizes.

According to one or more embodiments, the adhesive layer (3) is partially embedded into to the waterproofing adhesive layer (3). The term “partially embedded” is understood to mean that the plane of the outer major surface of the adhesive layer (3) coincides with or lies above the plane of the first major surface of the waterproofing adhesive layer (2). According to one or more embodiments, not more than 25%, preferably not more than 20%, more preferably not more than 15%, even more preferably not more than 5%, of the thickness of the adhesive layer (3) extends beyond the plane of the first major surface of the waterproofing adhesive layer (2).

The sealing element comprises as a third compulsory element a carrier layer (4) on the side of the waterproofing adhesive layer (2) that is opposite to the side of the adhesive layer (3). Preferably, the carrier layer (4) covers at least 75%, more preferably at least 85%, even more preferably at least 95%, still more preferably at least 97.5%, of the total area of the second major surface of the waterproofing adhesive layer (2).

According to one or more embodiments, the waterproofing adhesive layer (2) and the carrier layer (4) are directly connected over at least a portion of their opposing major surfaces. The expression “directly connected” is understood to mean in the context of the present invention that no further layer or substance is present between the layers and that the opposing surfaces of the layers are directly bonded to each other or adhere to each other. At the transition area between the two layers, the materials of the layers can also be present mixed with each other.

The carrier layer (4) can be composed of a single layer or it can be a multilayer composite foil comprising several layers having same or different compositions. Suitable layers for use in the carrier layer (4) include, for example, polymeric layers, polymer-modified bitumen layers, metal films, layers of fiber material, and particle-based layers. The term “polymeric film” refers in the present disclosure to a film comprising a continuous phase composed of one or more polymers whereas the term “particle-based layer” refers to a layer composed of solid particles.

According to or more embodiments, carrier layer (4) comprises at least one layer selected from the group consisting of a polymeric layer, polymer-modified bitumen layer, metal film, layer of fiber material, and a particle-based layer.

Suitable polymeric layers for use in the carrier layer (4) include singly-layer and multi-layer polymeric foils, particularly polymeric foils composed of or comprising polyethylene, particularly cross-laminated high-density polyethylene (HDPE), polypropylene, polyvinylchloride (PVC), polyethylene terephthalate (PET), polystyrene (PS), polyamides (PA), chlorosulfonated polyethylene (CSPE), ethylene propylene diene rubber (EPDM), and polyisobutylene (PIB).

Suitable polymer-modified bitumen layers for use in the carrier layer (4) comprise bitumen as the main constituent and one or more modifying polymers, preferably selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, more preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

Especially suitable metal films for use in the carrier layer (4) include aluminum films. Composite films comprising one or more metal films and one or more polymeric films are also suitable. Suitable particle-based layers include, for example, particle-based layers of inert mineral particles, preferably comprising or composed of sand, talcum, gravel, or slates.

Suitable layers of fiber material include non-woven fabrics and laid scrims comprising synthetic organic and/or inorganic fibers. The term “non-woven fabric” designates in the present disclosure materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90±5°, towards each other thereby forming interstices, wherein the interstices occupy more than 60% of the entire surface area of the laid scrim. Typical materials for laid scrims include metal fibers, inorganic fibers, in particular glass fibers, and synthetic organic fibers, particularly polyester, polypropylene, polyethylene, and polyethylene terephthalate (PET).

Especially suitable layers of fiber material for use in the carrier layer (4) include non-woven fabrics comprising synthetic organic and/or inorganic fibers and having a mass per unit weight of not more than 500 g/m₂, preferably not more than 350 g/m₂, particularly 15-350 g/m₂, preferably 25-300 g/m₂, more preferably 35-250 g/m₂, even more preferably 50-200 g/m₂. Preferred synthetic organic fibers include polyester fibers, polypropylene fibers, polyethylene fibers, nylon fibers, and polyamide fibers whereas glass fibers, aramid fibers, wollastonite fibers, and carbon fibers are preferred inorganic fibers for the non-woven fabrics.

According to one or more embodiments, the carrier layer (4) comprises at least one polymer-modified bitumen layer, a surface finish layer, and optionally a reinforcement layer, wherein the surface finish layer is preferably selected from the group consisting of a polymeric layer, a metal film, and a particle-based layer and wherein the reinforcement layer is preferably selected from the group consisting of a layer of fiber material, a polymeric layer, and a metal film. The surface finish layer preferably forms one of the outermost layers of the carrier layer (4), more preferably one of the outermost layers of the sealing element.

According to one or more embodiments the carrier layer (4) comprises a polymer-modified bitumen layer, preferably having a thickness of 0.1-1.5 mm, more preferably 0.25-1 mm, and a surface finish layer, preferably a polymeric layer, preferably having a thickness of 15-250 μm, more preferably 35-150 μm, wherein the polymer-modified bitumen layer and the waterproofing adhesive layer (2) are directly connected to each other over at least a portion of their opposing major surfaces and wherein the surface finish layer covers at least a portion of the outer major surface of the polymer-modified bitumen layer facing away from the waterproofing adhesive layer (2).

According to one or more embodiments, the carrier layer (4) comprises first and second polymer-modified bitumen layers and a surface finish layer, wherein the first polymer-modified bitumen layer and the waterproofing adhesive layer (2) are directly connected to each other over at least a portion of their opposing major surfaces and wherein the surface finish layer covers at least a portion of the outer major surface of the second polymer-modified bitumen layer facing away from the first polymer-modified bitumen layer.

According to one or more embodiments, the carrier layer (4) further comprises a reinforcement layer, preferably a layer of fiber material, arranged between the first and second polymer-modified bitumen layers, wherein the layer of fiber material is a woven fabric, preferably having as the main fiber component synthetic organic fibers or inorganic fibers, preferably synthetic organic fibers selected from the group consisting of polyester fibers, polypropylene fibers, polyethylene fibers, nylon fibers, and polyamide fibers.

According to one or more embodiments, the first and second polymer-modified bitumen layers have the same composition as the waterproofing adhesive layer (2). According to one or more further embodiments, the first and second polymer-modified bitumen layers have the same composition, which is different from the composition of the waterproofing adhesive layer (2). According to one or more further embodiments, the first and second polymer-modified bitumen layers have different compositions, wherein the first polymer-modified layer and the waterproofing adhesive layer (2) have the same composition. According to one or more further embodiments, the first and second polymer-modified bitumen layers and the waterproofing adhesive layer (2) have different compositions.

Preferably, the carrier layer (4) has a non-tacky primary exterior surface facing away from the waterproofing adhesive layer (2). According to one or more embodiments, primary exterior surface of the carrier layer (4) facing away from the waterproofing adhesive layer (2) has a loop tack adhesion to a glass plate measured at a temperature of 23° C. of not more than 0.5 N/25 mm, preferably not more than 0.25 N/25 mm, more preferably not more than 0.1 N/25 mm, wherein the loop tack adhesion is measured using a ″FINAT test method no. 9 (FTM 9) as defined in FINAT Technical Handbook, 9th edition, published in 2014.

Preferably, the carrier layer (4) has a thickness of not more than 10 mm, more preferably not more than 6 mm, even more preferably not more than 5 mm. According to one or more embodiments the carrier layer (4) has a thickness of 0.5-10 mm, preferably 1-7.5 mm, more preferably 2.5-6 mm.

According to one or more embodiments, the sealing element further comprises a release liner (6) covering at least a portion of the outer major surface of the adhesive layer (3) facing away from the waterproofing adhesive layer (2).

The release liner may be used to prevent premature unwanted adhesion and to protect the adhesive layer (3) from moisture, fouling, and other environmental factors. In case the sealing element is provided in form of rolls, the release liner enables ease of unwind without sticking of the waterproofing adhesive layer (2) and/or the adhesive layer (3) to the back side of the sealing element. The release liner (6) may be sliced into multiple sections to allow portioned detachment of the liner from the surface of the sealing element.

Suitable materials for the release liner (6) include Kraft paper, polyethylene coated paper, silicone coated paper as well as polymeric films, for example, polyethylene, polypropylene, and polyester films coated with polymeric release agents selected from silicone, silicone urea, urethanes, waxes, and long chain alkyl acrylate release agents.

There are no particular limitations for the width (w) of the sealing element and the preferred ranges for the width depend on the intended use of the sealing element. For example, the sealing element can be provided in form of a narrow strip having a width, for example, in the range of 10-500 mm, such as 50-350 mm, particularly 75-250 mm. These types of sealing elements are suitable for use, for example, as self-adhering tapes, especially waterproofing, roofing, and façade tapes. Furthermore, the sealing element can be provided in form of a broad sheet having a width, for example, in the range of 0.75-5 m, such as 1-3 m, particularly 1-2.5 m. These types of sealing elements are suitable for use, for example, as membranes, especially waterproofing, roofing, vapor barrier, vapor retarder, or façade membranes.

The preferences given above for the waterproofing adhesive layer (2), adhesive layer (3), carrier layer (4), and release liner (5) apply equally to all aspects of the present invention unless otherwise stated.

Another subject of the present invention is use of the sealing element (1) according to the present invention as a waterproofing, roofing, vapor barrier, vapor retarder, or a façade membrane, or as a waterproofing, roofing, or façade tape.

Still another subject of the present invention is a method for producing a sealing element (1) according to the present invention, the method comprising steps of:
i) providing a carrier layer (4),
ii) applying a self-adhering bituminous composition to the carrier layer (4) to form a waterproofing adhesive layer (2) having first and second major surfaces, iii) applying a non-bituminous pressure sensitive adhesive composition to the waterproofing adhesive layer (2) such that the first major surface of the waterproofing adhesive layer (2) is at least partially covered with an adhesive layer (3), and
iv) optionally covering the outer major surface of the adhesive layer (3) facing away from the waterproofing adhesive layer (2) with a release liner (5).

The self-adhering bituminous composition and the non-bituminous pressure sensitive adhesive composition may be applied to the respective surfaces using any conventional techniques, such as by using lamination, extrusion, calendaring, spread coating, slot die coating, extrusion coating, roller coating, direct gravure coating, offset gravure coating, reverse gravure roll coating, powder dispersion, or spray lamination techniques.

The further details of the method for producing the sealing element depend on the structure of the individual layers of the sealing element, particularly on the compositions of the adhesive and carrier layers.

According to one or more embodiments, the non-bituminous pressure sensitive adhesive composition is a hot-melt pressure sensitive adhesive composition and step iii) of the method comprises:
heating the hot-melt pressure sensitive adhesive composition to allow the composition to flow and
applying the heated a hot-melt pressure sensitive adhesive composition as an adhesive film to the first major surface of the waterproofing adhesive layer (2) or
heating the hot-melt pressure sensitive adhesive composition to allow the composition to flow,
applying the heated hot-melt pressure sensitive adhesive composition as an adhesive film to a surface of transfer sheet, and
transferring the adhesive film to the first major surface of the waterproofing adhesive layer (2).

It may be preferred that the hot-melt pressure sensitive adhesive composition is heated to a temperature in the range of 60-250° C., such as 70-225° C., in particular 80-200° C.

According to one or more embodiments, the non-bituminous pressure sensitive adhesive composition is a water- or solvent-based pressure sensitive adhesive composition and step iii) of the method comprises:
applying the water- or solvent-based pressure sensitive adhesive composition as a wet adhesive film to the first major surface of the waterproofing adhesive layer (2) and
drying the wet adhesive film by allowing the volatile components to evaporate, or
applying the water- or solvent-based acrylic pressure sensitive adhesive composition as a wet adhesive film to a surface of transfer sheet,
at least partially drying the wet adhesive film by allowing at least a portion of the volatile components to evaporate, and
transferring the at least partially dried adhesive film to the first major surface of the waterproofing adhesive layer (2).

According to one or more embodiments, non-bituminous pressure sensitive is a UV- or electron beam-curable pressure sensitive adhesive composition and step iii) of the method comprises:
applying the UV- or electron beam-curable pressure sensitive adhesive composition as an adhesive film to the first major surface of the waterproofing adhesive layer (2) and
at least partially curing the adhesive film by subjecting the adhesive film to UV- or electron beam radiation, or
applying the UV- or electron beam-curable pressure sensitive adhesive composition as an adhesive film to a surface of transfer sheet,
at least partially curing the adhesive film by subjecting the adhesive film to UV- or electron beam radiation, and
transferring the at least partially cured adhesive film to the first major surface of the waterproofing adhesive layer (2).

Still another subject of the present invention is a method for covering a substrate comprising steps of:
I) Providing one or more sealing elements according to the present invention,
II) Applying the sealing elements(s) on a surface of the substrate such that at least a portion of the outer major surface of the adhesive layer facing away from the waterproofing adhesive layer and/or a portion of the first major surface of the waterproofing adhesive layer is directly contacted with the surface of the substrate, and
III) Pressing sealing elements(s) against the surface of the substrate with a pressure sufficient to affect adhesive bonding between the sealing element(s) and the substrate.

Still another subject of the present invention is a sealed substrate comprising a substrate (6) and a sealing element (1) according to the present invention, wherein at least a portion of the outer major surface of the adhesive layer (3) facing away from the waterproofing adhesive layer (2) and a portion of the first major surface of the waterproofing adhesive layer (2) are directly connected to the surface of the substrate (7).

The substrate (7) can be any structural or civil engineering structure, which is to be sealed against moisture, water, or harmful gases, such as a hardened concrete structure, insulation board, a cover board, an existing membrane, or a façade.

### EXAMPLES

### Build-Up of Sealing Elements

Inventive sealing element A composed of:
self-adhering bitumen membrane (SikaBit® S-515, from Sika Automotive Frankfurt-Worms GmbH) comprising a carrier layer composed of a polyethylene film (surface finish) and a polymer-modified bitumen layer, the carrier layer having a total thickness of 0.7 mm, and a bitumen-based waterproofing adhesive layer having a thickness of 0.4 mm arranged on the polymer-modified bitumen layer,
an adhesive layer in form of spaced-apart longitudinally extending stripes having a width of 25 mm and composed of UV-cured acrylic pressure sensitive adhesive (medium AC-resin, from BASF) coated onto the first (top) major surface of the waterproofing adhesive layer. The adhesive layer had a thickness of 0.1 mm and coverage of 50% of the surface of the bitumen-based waterproofing adhesive layer.

Reference sealing element B composed of the self-adhering bitumen membrane (SikaBit® S-515, from Sika Automotive Frankfurt-Worms GmbH)

Inventive sealing element C composed of:
a self-adhering bitumen membrane (from Sika Automotive Frankfurt-Worms GmbH) comprising a carrier layer composed of a polymeric layer having a thickness of 0.1 mm and a bitumen-based waterproofing adhesive layer having a thickness of 0.6 mm arranged on the carrier layer and
an adhesive layer in form of spaced-apart longitudinally extending stripes having a width of 25 mm and composed of UV-cured acrylic pressure sensitive adhesive (medium AC-resin, from BASF) coated onto the first (top) major surface of the waterproofing adhesive layer. The adhesive layer had a thickness of 0.1 mm and coverage of 50% of the surface of the bitumen-based waterproofing adhesive layer.

### Adhesive Bond Strength

Adhesive bond strength of the sealing elements was tested by measuring average peel resistances obtained upon peeling a sealing element from a surface of a substrate (wood, concrete) to which the tested sealing element had been bonded.

The adhesive bond strengths were measured one hour or one day after the sealing element had been adhered to surface of the substrate. The bonding of the sealing elements to substrates and the measurement of peel strengths were conducted in a climatized chamber at temperature of 5 and 10° C. All the materials needed in the measurements had also been stored overnight at the respective temperature before conducting of the measurements.

The peel resistances were measured using the method as defined in EN DIN 1372 standard and using a Zwick tensile testing apparatus equipped with a 90°-peeling element. In the peel resistance measurements, a sample strip of the tested sealing element was peeled off at a peeling angle of 90° and a constant cross beam speed of 100 mm/min. The average peel resistance was calculated as average peel force per unit width of the strip [N/50 mm] during peeling over a length of approximately 10 cm excluding the first and last fifth of the total peeling length from the calculation. The average peel resistance values shown in Table 1 were calculated as an average of measured values obtained with three identical sealing elements.

TABLE 1

| | Ex-1 | Ref-1 | Ex-2 |
|---|---|---|---|
| Sealing element | A | B | C |
| Peel resistance form wood [N/50 mm] | | | |
| After 1 h, @10° C. | 30 | 25 | 26 |
| After 24 h, @10° C. | 47 | 29 | 44 |
| After 1 h, @5° C. | 26 | 11 | 11 |
| After 24 h, @5° C. | 45 | 22 | 23 |
| After 1 h, @RT | | 15 | |
| After 24 h, @RT | | 26 | |
| Peel resistance from concrete [N/50 mm] | | | |
| After 1 h, @10° C. | 132 | 64 | 88 |
| After 24 h, @10° C. | 155 | 61 | 91 |
| After 1 h, @5° C. | 68 | 7 | 72 |
| After 24 h, @5° C. | 128 | 11 | 79 |
| After 1 h, @RT | | 40 | |
| After 24 h, @RT | | 91 | |

1. A sealing element comprising:
i. A waterproofing adhesive layer having first and second major surfaces,
ii. An adhesive layer covering at least a portion of the first major surface of the waterproofing adhesive layer, and
iii. A carrier layer on the side of the waterproofing adhesive layer opposite to the side of the adhesive layer, wherein
the waterproofing adhesive layer is composed of a self-adhering bituminous composition and the adhesive layer is composed of a non-bituminous pressure sensitive adhesive.

2. The sealing element according to claim 1, wherein the self-adhering bituminous composition comprises:
a) 15-95 wt.-%, of bitumen B and
b) 5-35 wt.-%, of at least one modifying polymer MP, all proportions being based on the total weight of the self-adhering bituminous composition.

3. The sealing element according to claim 2, wherein the self-adhering bituminous composition further comprises:
c) 2.5-30 wt.-%, of at least one tackifying resin TR and/or
d) 0.5-15 wt.-%, of at least one plasticizer PL and/or
e) 2.5-30 wt.-%, of at least one inorganic filler F, all proportions being based on the total weight of the self-adhering bituminous composition.

4. The sealing element according to claim 3, wherein the at least one plasticizer PL is selected from the group consisting of mineral oils, synthetic oils, vegetable oils, and at 25° C. liquid hydrocarbon resins.

5. The sealing element according to claim 1, wherein the waterproofing adhesive layer has a thickness of 0.1-5 mm.

6. The sealing element according to claim 1, wherein the non-bituminous pressure sensitive adhesive is an acrylic pressure sensitive adhesive.

7. The sealing element according to claim 1, wherein the adhesive layer is a dried layer of a water- or solvent-based acrylic pressure sensitive adhesive composition, a layer of a hot-melt acrylic pressure sensitive adhesive composition, or a at least partially cured layer of a UV- or electron beam-curable acrylic pressure sensitive adhesive composition.

8. The sealing element according to claim 1, wherein the adhesive layer has a thickness of 50-500 μm.

9. The sealing element according to claim 1, wherein the adhesive layer covers at least 5%, of the area of the first major surface of the waterproofing adhesive layer and/or not more than 95%, of the area of the first major surface of the waterproofing adhesive layer.

10. The sealing element according to claim 1, wherein the adhesive layer has a pattern comprising a plurality spaced-apart adhesive coated areas or a pattern comprising an adhesive coated area and a plurality of spaced-apart adhesive free areas.

11. The sealing element according to claim 10, wherein the spaced-apart adhesive coated areas are in form of continuous stripes extending in the longitudinal, transverse, or diagonal direction of the sealing element or in form of dots.

12. The sealing element according to claim 1, wherein the carrier layer comprises at least one layer selected from the group consisting of a polymeric layer, polymer-modified bitumen layer, metal film, layer of fiber material, and a particle-based layer.

13. The sealing element according to claim 1 further comprising a release liner covering at least a portion of the outer major surface of the adhesive layer facing away from the waterproofing adhesive layer.

14. A waterproofing, roofing, vapor barrier, vapor retarder, or a façade membrane, or as a waterproofing, roofing, or façade tape comprising the sealing element according to claim 1.

15. A method for producing a sealing element according to claim 1, the method comprising steps of:
i) providing a carrier layer,
ii) applying a self-adhering bituminous composition to the carrier layer to form a waterproofing adhesive layer having first and second major surfaces,
iii) applying a non-bituminous pressure sensitive adhesive composition to the waterproofing adhesive layer such that the first major surface of the waterproofing adhesive layer is at least partially covered with an adhesive layer, and
iv) optionally covering the outer major surface of the adhesive layer facing away from the waterproofing adhesive layer with a release liner.

16. A method for covering a substrate comprising steps of:
I) Providing one or more sealing elements according to claim 1,
II) Applying the sealing elements(s) on a surface of the substrate such that at least a portion of the outer major surface of the adhesive layer and/or a portion of the first major surface of the waterproofing adhesive layer is directly contacted with the surface of the substrate, and
III) Pressing sealing elements(s) against the surface of the substrate with a pressure sufficient to affect adhesive bonding between the sealing element(s) and the substrate.
